(19) United States
(12) Patent Application Publication
(10) Pub. No.: US 2022/0044559 A1
(43) Pub. Date: Feb. 10, 2022

(54) METHOD AND APPARATUS FOR OUTPUTING VEHICLE FLOW DIRECTION, ROADSIDE DEVICE, AND CLOUD CONTROL PLATFORM

(71) Applicant: Apollo Intelligent Connectivity (Beijing) Technology Co., Ltd., Beijing (CN)

(72) Inventors: Xu GAO, Beijing (CN); Wei ZHANG, Beijing (CN); Xiao TAN, Beijing (CN)

(21) Appl. No.: 17/507,711

(22) Filed: Oct. 21, 2021

(30) Foreign Application Priority Data
Dec. 21, 2020 (CN) 202011516253.6

(51) Int. Cl. G08G 1/01

(52) U.S. Cl. CPC G08G 1/0145; G08G 1/0133; G08G 1/0116

(57) ABSTRACT

Embodiments of the present disclosure provide a method and apparatus for outputting a vehicle flow direction, a roadside device, and a cloud control platform. The method may include: acquiring a traveling trajectory of a vehicle; acquiring a flow direction curve set corresponding to a road, the flow direction curve set including at least one flow direction curve representing the vehicle flow direction; determining a similarity between each flow direction curve in the flow direction curve set and the traveling trajectory; and selecting a flow direction curve having a highest similarity to the traveling trajectory from the flow direction curve set as a flow direction of the traveling trajectory, and outputting the flow direction of the traveling trajectory.

### CROSS-REFERENCE TO RELATED APPLICATIONS

This application claims priority to Chinese Patent Application No. 202011516253.6, filed on Dec. 21, 2020, titled “Method and apparatus for outputting vehicle flow direction, roadside device, and cloud control platform,” which is hereby incorporated by reference in its entirety.

### TECHNICAL FIELD

The present disclosure relates to the field of computer technology, and more particularly, to the field of artificial intelligence such as intelligent traffic and autonomous driving, and more particularly, to a method and apparatus for outputting a vehicle flow direction, a roadside device, and a cloud control platform.

### BACKGROUND

An intelligent transportation system effectively integrates advanced science and technology (information technology, computer technology, data communication technology, sensor technology, electronic control technology, automatic control theory, operation research, artificial intelligence, and the like) for transportation, service control, and vehicle manufacturing, and strengthens connections among vehicles, roads, and users, thereby forming an integrated transportation system that ensures safety, improves efficiency, improves environment, and saves energy.

In intelligent traffic, counting vehicles of different flow directions is an important problem, and may be used to analyze traffic intersections so as to better dynamically adjust control signals.

### SUMMARY

Embodiments of the present disclosure provide a method and apparatus for outputting a vehicle flow direction, a roadside device, and a cloud control platform.

According to a first aspect, an embodiment of the present disclosure provides a method for outputting a vehicle flow direction, including: acquiring a traveling trajectory of a vehicle; acquiring a flow direction curve set corresponding to a road, wherein the flow direction curve set comprises at least one flow direction curve representing the vehicle flow direction; determining a similarity between each flow direction curve in the flow direction curve set and the traveling trajectory; and selecting a flow direction curve having a highest similarity to the traveling trajectory from the flow direction curve set as a flow direction of the traveling trajectory, and outputting the flow direction of the traveling trajectory.

According to a second aspect, an embodiment of the present disclosure provides an apparatus for outputting a vehicle flow direction, including: a first acquiring module, configured to acquire a traveling trajectory of a vehicle; a second acquiring module, configured to acquire a flow direction curve set corresponding to a road, wherein the flow direction curve set comprises at least one flow direction curve representing the vehicle flow direction; a determining module, configured to determine a similarity between each flow direction curve in the flow direction curve set and the traveling trajectory; and an output module, configured to select a flow direction curve having a highest similarity to the traveling trajectory from the flow direction curve set as a flow direction of the traveling trajectory and output the flow direction of the traveling trajectory.

According to a third aspect, an embodiment of the present disclosure provides an electronic device, including at least one processor; and a memory communicatively connected with the at least one processor. The memory stores instructions executable by the at least one processor, the instructions when executed by the at least one processor, cause the at least one processor to perform the method as described in any of the implementations in the first aspect.

According to a fourth aspect, an embodiment of the present disclosure provides a non-transitory computer-readable storage medium, storing computer instructions, the computer instructions being used to cause a computer to perform the method as described in any of the implementations in the first aspect.

It should be understood that the contents described in this section is not intended to identify key or important features of embodiments of the present disclosure, nor is it intended to limit the scope of the present disclosure. Other features of the present disclosure will be easily understood by the following description.

### DESCRIPTION OF THE DRAWINGS

Other features, objects, and advantages of the present disclosure will become more apparent by reading the following detailed description of non-limiting embodiments made with reference to the accompanying drawings. The drawings are intended to provide a better understanding of the present disclosure and are not to be construed as limiting the disclosure.

FIG. 1 is an example system architecture diagram in which embodiments of the present disclosure may be applied;

FIG. 2 is a flow diagram of a method for outputting a vehicle flow direction according to an embodiment of the present disclosure;

FIG. 3 is a flow diagram of the method for outputting a vehicle flow direction according to another embodiment of the present disclosure;

FIG. 4 is a schematic diagram of an application scenario of the method for outputting a vehicle flow direction according to an embodiment of the present disclosure;

FIG. 5 is a schematic structural diagram of an apparatus for outputting a vehicle flow direction according to an embodiment of the present disclosure;

FIG. 6 is a block diagram of an electronic device for implementing the method for outputting a vehicle flow direction according to embodiments of the present disclosure.

### DETAILED DESCRIPTION OF EMBODIMENTS

The present disclosure is described in further detail below with reference to accompanying drawings and embodiments. It is to be understood that the specific embodiments described herein are merely illustrative of the related disclosure and are not restrictive of the disclosure. It is also to be noted that, for ease of description, only parts related to the disclosure are shown in the drawings.

It should be noted that embodiments in the present disclosure and features in the embodiments may be combined with each other without conflict. The present disclosure will now be described in detail with reference to the accompanying drawings and embodiments.

When the traffic flow at a traffic intersection is counted, the existing technical solutions are mostly counted in a manual manner. That is, at the traffic intersection, the positions of the exit and the entrance are marked, a corresponding relationship table of the exit and the entrance is established, and the vehicle flow direction is judged by contrasting the vehicle trajectories and the table.

However, the existing technical solutions have at least two disadvantages as follows.

(1) If the vehicle is blocked when driving out or into an intersection, the vehicle may not be detected, and therefore, the position to the exit or entrance cannot be detected, thereby causing an error in calculating the traffic flow;

(2) If the vehicle is located at the center of the intersection at the start of the statistics, the corresponding relationship cannot be established in the corresponding relationship table, and incorrect traffic flow statistics may be caused.

In view of the above-mentioned drawbacks of the existing technical solutions, an embodiment of the present disclosure provides a method for outputting a vehicle flow direction.

FIG. 1 illustrates an example system architecture 100 in which a method for outputting a vehicle flow or apparatus for outputting a vehicle flow direction of embodiments of the present disclosure may be applied.

As shown in FIG. 1, the system architecture 100 may include a terminal device 101, a network 102, and a server 103. The network 102 serves as a medium for providing a communication link between the terminal device 101 and the server 103. Network 102 may include various types of connections, such as wireless communication links, and the like.

Terminal device 101 may interact with server 103 through network 102. A traveling trajectory of the vehicle or the like may be provided in the terminal device 101, including but not limited to an onboard device or the like.

The server 103 may provide various services. For example, the server 103 may perform processing such as analysis on data such as a traveling trajectory of a vehicle acquired from the terminal device 101, to generate a processing result (for example, a flow direction of the vehicle).

It should be noted that the server 103 may be hardware or software. When the server 103 is the hardware, the server 103 may be implemented as a distributed server cluster composed of a plurality of servers, or may be implemented as a single server. When the server 103 is the software, the server 103 may be implemented as a plurality of pieces of software or a plurality of software modules (e.g., software or software modules for providing a distributed service), or may be implemented as a single piece of software or a single software module, which will not be specifically defined here.

It should be noted that the method for outputting a vehicle flow direction according to the embodiment of the present disclosure is generally executed by the server 103, and accordingly, the apparatus for outputting a vehicle flow direction is generally provided in the server 103.

It should be understood that the number of terminal devices, networks and servers in FIG. 1 is merely illustrative. There may be any number of terminal devices, networks, and servers as desired for implementation.

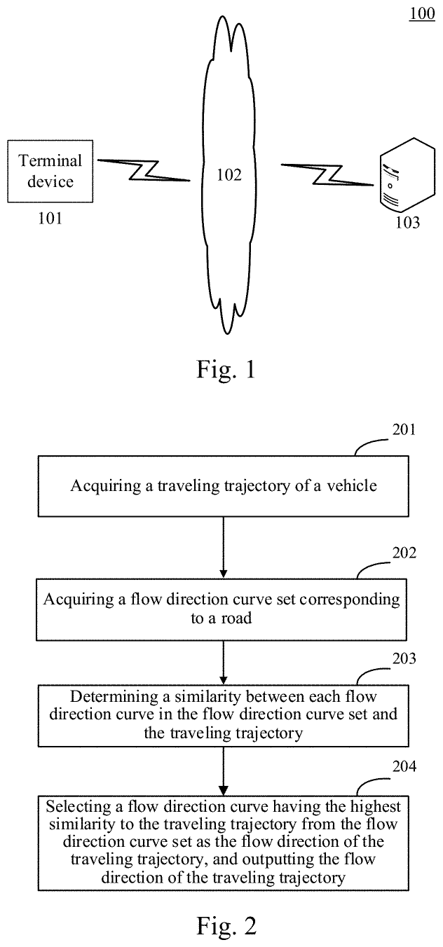

With continuing reference to FIG. 2, a flow diagram 200 of a method for outputting a vehicle flow direction according to an embodiment of the present disclosure is shown. The method includes the following steps.

Step 201, acquiring a traveling trajectory of a vehicle.

In the present embodiment, an executing body (for example, the server 103 shown in FIG. 1) of the method for outputting a vehicle flow direction may acquire a traveling trajectory of a vehicle.

The vehicle position may be obtained by positioning a vehicle by a GPS positioning device or an Inertial Measurement Unit (IMU), and the traveling trajectory of the vehicle may be drawn according to the vehicle position at each time.

Step 202, acquiring a flow direction curve set corresponding to a road.

In the present embodiment, the executing body may acquire a flow direction curve set corresponding to a road.

The flow direction curve may be used to represent the flow direction of the vehicle. For example, when the flow direction curve is a straight line, the straight line may represent that the flow direction of the vehicle is going straight.

Depending on the types of roads, all possible flow direction curves corresponding thereto are also different. For example, an intersection is a collection of four roads, and all possible flow direction curves of each road are straight lines, left-turn lines, and right-turn lines, respectively. Therefore, the intersection has a total of 12 flow direction curves.

All the flow direction curves corresponding to the road may be formed into a flow direction curve set, and each flow direction curve in the flow direction curve set is subjected to discretization processing to obtain a point set of each flow direction curve.

Step 203: determining a similarity between each flow direction curve in the flow direction curve set and the traveling trajectory.

In the present embodiment, the executing body may determine the similarity between each flow direction curve in the flow direction curve set and the traveling trajectory.

Here, each flow direction curve after the discretization process may be set as a flow direction trajectory, and the similarity between the flow direction trajectory and the traveling trajectory may be determined one by one to obtain the similarity (e.g., 90%) between each flow direction trajectory and the traveling trajectory.

The determination of the similarity between the flow direction trajectory and the traveling trajectory may use a point-based method such as a Longest-Common-Subsequence (LCSS), a Dynamic Time Warping (DTW), or the like.

The LCSS problem may be efficiently solved by the dynamic programming method. Two sequences X, and Y are taken as an example: assuming that a two-dimensional array f[i,j] represents the length of the LCSS preceding the i bit of X and the j bit of Y, then: F[1][1]=same (1,1); f[i, j]=max {f[i−1][j−1]+same (i, j), f[i−1, j], f[i, j−1]}; where same (a, b) is “1” when the a-th bit of X is the same as the b-th bit of Y, otherwise same (a, b) is “0”. In this time, the largest number in the two-dimensional array is the length of the LCSS of X and Y, and the LCSS may be found based on the backtracking of the array.

DTW is a method of measuring the similarity of two sequences of different lengths, which is a typical optimization problem. Applying the time regulation function W(n) satisfying a certain condition to describe the time correspondence between the test template and the reference template, and solve the regulation function corresponding to the minimum cumulative distance when the two templates match each other. When the similarity index value is calculated using DTW, the dtw value between the traveling trajectory and any one of the flow direction trajectories is calculated, and the smaller the dtw value is, the more similar the two sets of information are.

Step 204: selecting a flow direction curve having the highest similarity to the traveling trajectory from the flow direction curve set as the flow direction of the traveling trajectory, and outputting the flow direction of the traveling trajectory.

In the present embodiment, the executing body may select the flow direction curve having the highest similarity to the traveling trajectory from the flow direction curve set as the flow direction of the traveling trajectory, and output the flow direction of the traveling trajectory.

Here, by performing the step 203, it is possible to obtain the similarity between each flow direction curve in the flow direction curve set and the traveling trajectory, and then perform the optimal similarity judgment on these similarities. Here, the flow direction curve with the highest similarity may be selected as the flow direction of the traveling trajectory and then output the flow direction of the traveling trajectory.

According to the method for outputting a flow direction of the vehicle provided in embodiments of the present disclosure, the drawback of counting the traffic flow in a manual manner can be solved, that is, no matter the vehicle is blocked when driving out/into an intersection, or the vehicle is located in the center of the intersection when starting the counting, the traffic flow statistics can be correctly performed.

In some alternative implementations of the present embodiment, the step 203 includes: determining the similarity between the flow direction curve and the traveling trajectory based on a shape similarity between the flow direction curve and the traveling trajectory.

Here, calculating the similarity between the flow direction curve and the traveling trajectory may be performed based on a shape method such as a Frechet Distance and a Hausdorff Distance. Here, the Frechet distance may be used to solve the similarity between trajectories, and the steps are as follows: selecting a flow direction curve trajectory P in the flow direction curve set and a traveling trajectory Q, where the trajectory length of P is M and the trajectory length of Q is N, and constraining the variable t to the interval [0, 1], where α(t) and β(t) are motion position description functions; then α(0)=0, α(1)=N, β(0)=0, β(0)=M. Using P(α(t)) and Q(β(t)) denote the spatial positions of P and Q at time t on the respective trajectories, respectively; The Frechet distance is to search a pair of such functions to minimize the maximum distance between P and Q. The distance between the point sets of P trajectory and Q trajectory may be obtained by the Freezer distance. The smaller the distance, the higher the similarity between the two trajectory estimates; and the larger the distance, the lower the degree of similarity between the two trajectories.

Hausdorff distance is a method of measuring the maximum value among the minimum distances of two spatial geometric objects, the greater the Hausdorff distance, the greater the similarity, and conversely, the smaller the Hausdorff distance, the smaller the similarity.

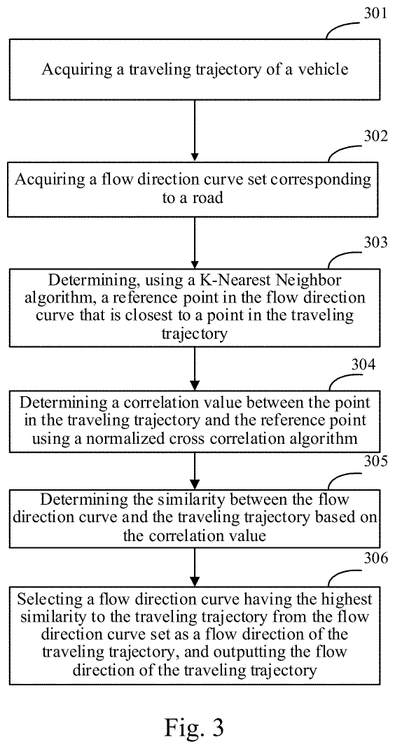

Referring further to FIG. 3, there is shown a flow chart of the method for outputting a vehicle flow direction according to another embodiment, and the method includes the following steps.

Step 301, acquiring a traveling trajectory of a vehicle.

Since step 301 is substantially the same as step 201, details are not repeated herein.

Step 302, acquiring a flow direction curve set corresponding to a road.

Since step 302 is substantially the same as step 202, details are not repeated herein.

Step 303, determining, using a K-Nearest Neighbor algorithm, a reference point in the flow direction curve that is closest to a point in the traveling trajectory.

Here, the core idea of the K-Nearest Neighbor (KNN) algorithm is that, for a sample, if the majority of k nearest neighbor samples of this sample in a feature space belong to one category, this sample also belongs to this category and has the characteristics of samples of this category.

Here, the optional common sub-segments A and B of the flow direction curve and the traveling trajectory are first found by the K-Nearest Neighbor algorithm. For the first point P1 of the A trajectory, finding the closest point Q1 of the P1 from all points in the B trajectory, and for the second point P2 of the A trajectory, finding the closest point Q2 of the P2 from all points in the B trajectory, and so on, then forming a reference set of points of the A trajectory and reference set of points of the B trajectory.

Step 304, determining a correlation value between the point in the traveling trajectory and the reference point using a normalized cross correlation algorithm.

Normalized Cross Correlation (NCC) algorithm is a matching algorithm based on a similarity measure. A correlation value between the reference sets in step 304 may be calculated using the NCC algorithm. The similarity measure (Similarity) is to calculate the degree of similarity between individuals. In contrast to the distance measure, the smaller the value of the similarity measure, the smaller the degree of similarity between individuals, and the larger the difference. Normalization is a way of simplifying a calculation, that is, transforming a dimensional expression into a nondimensional expression to become a scalar. The normalized correlation algorithm is such that the range of correlation coefficients is [−1, 1], and the data is mapped to this range for processing.

Step 305: determining the similarity between the flow direction curve and the traveling trajectory based on the correlation value.

Here, the correlation value between the reference sets calculated in step 304 may be used as the similarity between the corresponding flow direction curve and the traveling trajectory.

Step 306, selecting a flow direction curve having the highest similarity to the traveling trajectory from the flow direction curve set as a flow direction of the traveling trajectory, and outputting the flow direction of the traveling trajectory.

Since step 306 is substantially the same as step 204, details are not repeated herein.

In some alternative implementation of the present embodiment, the flow direction curve set in step 202 includes at least one of: a straight line, a left turn line, a right turn line, or a U-turn line. Here, the straight line represents that the flow direction of the vehicle is straight forward, the left turn line represents that the direction of the vehicle is left turn, and so on.

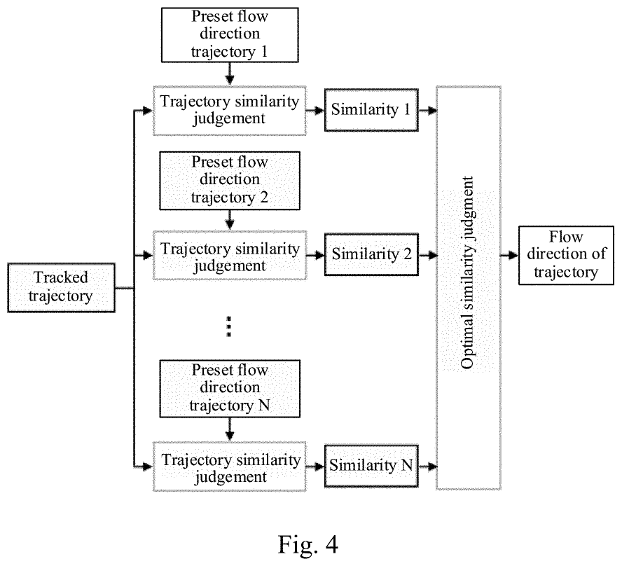

For ease of understanding, FIG. 4 shows a schematic diagram of an application scenario of the method for outputting a vehicle flow direction according to an embodiment of the present disclosure.

As shown in FIG. 4, a trajectory for vehicle tracking is first acquired; Then, all preset flow direction trajectories (flow direction trajectory 1, flow direction trajectory 2, . . . , flow direction trajectory N) corresponding to the road are acquired according to the condition of the road; then determining a similarity between the flow direction trajectories and the tracked trajectory one by one in a preset order to obtain the similarity (similarity 1, similarity 2, . . . , similarity N) between each flow direction trajectory and the tracked trajectory; finally, performing an optimal similarity judgment on all obtained similarities, and using the flow direction trajectory with the highest similarity as the flow direction of the tracked trajectory.

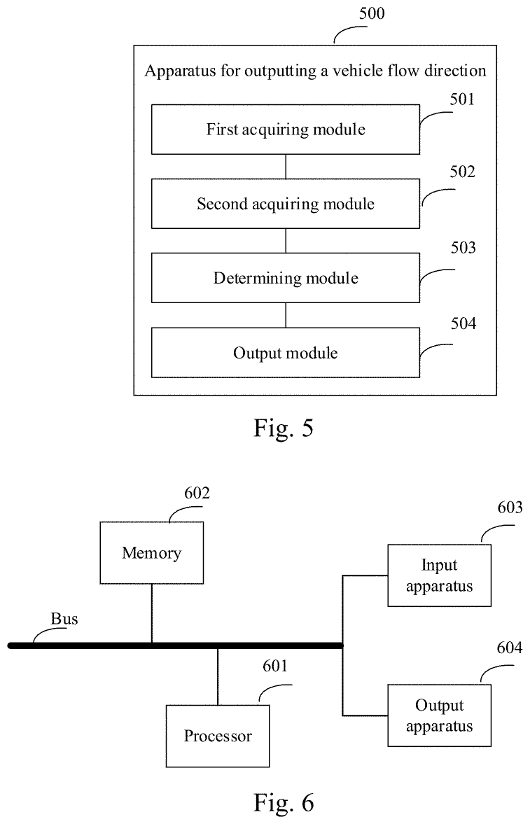

With further reference to FIG. 5, as an implementation of the method shown in each of the above figures, an embodiment of the present disclosure provides an apparatus for outputting a vehicle flow direction, which corresponds to the method embodiment shown in FIG. 2, and the apparatus is particularly applicable to various electronic devices.

As shown in FIG. 5, the apparatus 500 for outputting a vehicle flow direction according to the present embodiment may include a first acquiring module 501, a second acquiring module 502, a determining module 503, and an output module 504. The first acquiring module 501 is configured to acquire a traveling trajectory of a vehicle; the second acquiring module 502 is configured to acquire a flow direction curve set corresponding to the road, where the flow direction curve set includes at least one flow direction curve representing the vehicle flow direction; the determining module 503 is configured to determine a similarity between each flow direction curve in the flow direction curve set and the traveling trajectory; and the output module 504 is configured to select a flow direction curve having the highest similarity to the traveling trajectory from the flow direction curve set as a flow direction of the traveling trajectory and output the flow direction of the traveling trajectory.

In the apparatus 500 for outputting a vehicle flow direction in the present embodiment, the specific processing of the first acquiring module 501, the second acquiring module 502, the determining module 503, and the output module 504 and the technical effects thereof may be described with reference to the related description of steps 201-204 in the corresponding embodiment in FIG. 2, and details are not repeated herein again.

In some alternative implementations of the present embodiment, the determining module 503 is further configured to: determine, using a K-Nearest Neighbor algorithm, a reference point in the flow direction curve that is closest to a point in the traveling trajectory; determine a correlation value between the point in the traveling trajectory and the reference point using a normalized cross correlation algorithm; and determine the similarity between the flow direction curve and the traveling trajectory based on the correlation value.

In some alternative implementations of the present embodiment, the determining module 503 is further configured to determine the similarity between the flow direction curve and the traveling trajectory based on a shape similarity between the flow direction curve and the traveling trajectory.

In some alternative implementations of the present embodiment, the determining module 503 is further configured to determine the Hausdorff distance between the flow direction curve and the traveling trajectory, and use the Hausdorff distance as the similarity between the flow direction curve to the traveling trajectory.

In some alternative implementations of this embodiment, the flow direction includes at least one of: straight forward, left turn, right turn, or U-turn.

FIG. 6 is a block diagram of an electronic device suitable for outputting a vehicle flow direction according to an embodiment of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the electronic device includes: one or more processors 601, a memory 602, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories and a plurality of memories if desired. Similarly, a plurality of electronic devices may be connected, and the devices provide some necessary operations (for example, as a server array, a set of blade servers, or a multi-processor system). In FIG. 6, one processor 601 is used as an example.

The memory 602 is a non-transitory computer readable storage medium provided by the present disclosure. The memory stores instructions executable by at least one processor, so that the at least one processor performs the method for outputting a vehicle flow direction provided by the present disclosure. The non-transitory computer readable storage medium of the present disclosure stores computer instructions for causing a computer to perform the method for outputting a vehicle flow direction provided by the present disclosure.

The memory 602, as a non-transitory computer readable storage medium, may be used to store non-transitory software programs, non-transitory computer executable programs and modules, such as program instructions/modules corresponding to the method for outputting a vehicle flow direction in the embodiments of the present disclosure (for example, the first acquiring module 501, the second acquiring module 502, the determining module 5.3, and the output module 504 as shown in FIG. 5). The processor 601 executes the non-transitory software programs, instructions, and modules stored in the memory 602 to execute various functional applications and data processing of the server, that is, to implement the method for output module in the foregoing method embodiments.

The memory 602 may include a storage program area and a storage data area, where the storage program area may store an operating system and at least one function required application program; and the storage data area may store data created by the use of the electronic device according to the method for detecting a target object, etc. In addition, the memory 602 may include a high-speed random access memory, and may also include a non-transitory memory, such as at least one magnetic disk storage device, a flash memory device, or other non-transitory solid-state storage devices. In some embodiments, the memory 602 may optionally include memories remotely provided with respect to the processor 601, and these remote memories may be connected to the electronic device of the method for detecting a target object through a network. Examples of the above network include but are not limited to the Internet, intranet, local area network, mobile communication network, and combinations thereof.

The electronic device of the method for outputting a vehicle flow direction may further include: an input apparatus 603 and an output apparatus 604. The processor 601, the memory 602, the input apparatus 603, and the output apparatus 604 may be connected through a bus or in other methods. In FIG. 6, connection through a bus is used as an example.

The input apparatus 603 may receive input digital or character information, and generate key signal inputs related to user settings and function control of the electronic device of the method for detecting a target object, such as touch screen, keypad, mouse, trackpad, touchpad, pointing stick, one or more mouse buttons, trackball, joystick and other input apparatuses. The output apparatus 604 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

An embodiment of the present disclosure further provides a roadside device including the electronic device shown in FIG. 6. The roadside device may include, in addition to the electronic device, a communication component or the like, and the electronic device may be integrally integrated with the communication component or may be provided in separate units. The electronic device may acquire data of a sensing device (such as a roadside camera), such as pictures and videos, etc., to perform video processing and data calculation.

An embodiment of the present disclosure further provides a cloud control platform including the electronic device shown in FIG. 6. The cloud control platform performs processing on the cloud, and an electronic device included in the cloud control platform may acquire data of a sensing device (such as a roadside camera), such as pictures and videos, so as to perform video processing and data calculation; The cloud platform may also be referred to as a vehicle-road collaborative management platform, an edge computing platform, a cloud computing platform, a central system, a cloud server, or the like.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and a server. The client and the server are generally far from each other and usually interact through the communication network. The relationship between the client and the server is generated by computer programs that run on the corresponding computer and have a client-server relationship with each other.

According to the technical solution of the present disclosure, a traveling trajectory of a vehicle is first acquired; then a flow direction curve set corresponding to a road is acquired; thereafter a similarity between each flow direction curve in the flow direction curve set and the traveling trajectory is determined; and finally, a flow direction curve having the highest similarity to the traveling trajectory is selected from the flow direction curve set as the flow direction of the traveling trajectory and then is outputted, so that errors caused by manually counting the traffic flow can be solved.

Artificial intelligence is a discipline that makes computers simulate certain human thinking processes and intelligent behaviors (such as learning, reasoning, thinking, planning, etc.), at both the hardware level and the software level. Artificial intelligence hardware technologies generally include technologies such as sensors, dedicated artificial intelligence chips, cloud computing, distributed storage, large data processing, and the like; and artificial intelligence software technologies mainly includes computer vision technology, speech recognition technology, natural language processing technology, machine learning/deep learning, large data processing technology, knowledge map technology, and the like.

It should be understood that the various forms of processes shown above may be used to reorder, add, or delete steps. For example, the steps described in the present disclosure may be performed in parallel, sequentially, or in different orders. As long as the desired results of the technical solution disclosed in the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for outputting a vehicle flow direction, comprising:
acquiring a traveling trajectory of a vehicle;
acquiring a flow direction curve set corresponding to a road, wherein the flow direction curve set comprises at least one flow direction curve representing the vehicle flow direction;
determining a similarity between each flow direction curve in the flow direction curve set and the traveling trajectory; and
selecting a flow direction curve having a highest similarity to the traveling trajectory from the flow direction curve set as a flow direction of the traveling trajectory, and outputting the flow direction of the traveling trajectory.

2. The method of claim 1, wherein determining the similarity between each flow direction curve in the flow direction curve set and the traveling trajectory comprises:
determining, using a K-Nearest Neighbor algorithm, a reference point in the flow direction curve that is closest to a point in the traveling trajectory;
determining a correlation value between the point in the traveling trajectory and the reference point using a normalized cross correlation algorithm; and
determining the similarity between the flow direction curve and the traveling trajectory based on the correlation value.

3. The method of claim 1, wherein determining the similarity between each flow direction curve in the flow direction curve set and the traveling trajectory comprises:
determining the similarity between the flow direction curve and the traveling trajectory based on a shape similarity between the flow direction curve and the traveling trajectory.

4. The method of claim 3, wherein determining the similarity between the flow direction curve and the traveling trajectory based on the shape similarity between the flow direction curve and the traveling trajectory comprises:
determining a Hausdorff distance between the flow direction curve and the traveling trajectory, and using the Hausdorff distance as the similarity between the flow direction curve and the traveling trajectory.

5. The method of claim 1, wherein the flow direction comprises at least one of:
straight forward, left turn, right turn, or U-turn.

6. An electronic device, comprising:
at least one processor; and
a memory communicatively connected with the at least one processor;
wherein the memory stores instructions executable by the at least one processor, the instructions, when executed by the at least one processor, cause the at least one processor to perform operations, comprising:
acquiring a traveling trajectory of a vehicle;
acquiring a flow direction curve set corresponding to a road, wherein the flow direction curve set comprises at least one flow direction curve representing the vehicle flow direction;
determining a similarity between each flow direction curve in the flow direction curve set and the traveling trajectory; and
selecting a flow direction curve having a highest similarity to the traveling trajectory from the flow direction curve set as a flow direction of the traveling trajectory, and outputting the flow direction of the traveling trajectory.

7. The electronic device of claim 6, wherein determining the similarity between each flow direction curve in the flow direction curve set and the traveling trajectory comprises:
determining, using a K-Nearest Neighbor algorithm, a reference point in the flow direction curve that is closest to a point in the traveling trajectory;
determining a correlation value between the point in the traveling trajectory and the reference point using a normalized cross correlation algorithm; and
determining the similarity between the flow direction curve and the traveling trajectory based on the correlation value.

8. The electronic device of claim 6, wherein determining the similarity between each flow direction curve in the flow direction curve set and the traveling trajectory comprises:
determining the similarity between the flow direction curve and the traveling trajectory based on a shape similarity between the flow direction curve and the traveling trajectory.

9. The electronic device of claim 8, wherein determining the similarity between the flow direction curve and the traveling trajectory based on the shape similarity between the flow direction curve and the traveling trajectory comprises:
determining a Hausdorff distance between the flow direction curve and the traveling trajectory, and using the Hausdorff distance as the similarity between the flow direction curve and the traveling trajectory.

10. The electronic device of claim 6, wherein the flow direction comprises at least one of:
straight forward, left turn, right turn, or U-turn.

11. A non-transitory computer-readable storage medium, storing computer instructions, the computer instructions being used to cause a computer to perform operations, comprising:
acquiring a traveling trajectory of a vehicle;
acquiring a flow direction curve set corresponding to a road, wherein the flow direction curve set comprises at least one flow direction curve representing the vehicle flow direction;
determining a similarity between each flow direction curve in the flow direction curve set and the traveling trajectory; and
selecting a flow direction curve having a highest similarity to the traveling trajectory from the flow direction curve set as a flow direction of the traveling trajectory, and outputting the flow direction of the traveling trajectory.

12. The non-transitory computer-readable storage medium of claim 11, wherein determining the similarity between each flow direction curve in the flow direction curve set and the traveling trajectory comprises:
determining, using a K-Nearest Neighbor algorithm, a reference point in the flow direction curve that is closest to a point in the traveling trajectory;
determining a correlation value between the point in the traveling trajectory and the reference point using a normalized cross correlation algorithm; and
determining the similarity between the flow direction curve and the traveling trajectory based on the correlation value.

13. The non-transitory computer-readable storage medium of claim 11, wherein determining the similarity between each flow direction curve in the flow direction curve set and the traveling trajectory comprises:
determining the similarity between the flow direction curve and the traveling trajectory based on a shape similarity between the flow direction curve and the traveling trajectory.

14. The non-transitory computer-readable storage medium of claim 13, wherein determining the similarity between the flow direction curve and the traveling trajectory based on the shape similarity between the flow direction curve and the traveling trajectory comprises:
determining a Hausdorff distance between the flow direction curve and the traveling trajectory, and using the Hausdorff distance as the similarity between the flow direction curve and the traveling trajectory.

15. The non-transitory computer-readable storage medium of claim 11, wherein the flow direction comprises at least one of:
straight forward, left turn, right turn, or U-turn.

16. A roadside device, comprising the electronic device according to claim 6.

17. A cloud control platform, comprising the electronic device according to claim 6.
